(19) United States
(12) Patent Application Publication
(10) Pub. No.: US 2013/0217475 A1
(43) Pub. Date: Aug. 22, 2013

(54) SYSTEM AND METHOD FOR ALLOWING USERS TO PLACE PARLAY WAGERS VIA MOBILE COMPUTING DEVICES

(71) Applicant: ONEWORKS IP HOLDINGS LIMITED, (US)

(72) Inventor: Koh Chan Guan, Singapore (SG)

(73) Assignee: ONEWORKS IP HOLDINGS LIMITED, Road Town (VG)

(21) Appl. No.: 13/740,992

(22) Filed: Jan. 14, 2013

Related U.S. Application Data
(60) Provisional application No. 61/586,151, filed on Jan. 13, 2012.

(51) Int. Cl. G07F 17/32

(52) U.S. Cl. CPC G07F 17/3244
USPC 463/25

(57) ABSTRACT

A method of allowing a user to place a parlay wager via a mobile computing device is described herein. The method includes receiving, from the mobile computing device, a request to display information associated with a plurality of wagering events, and retrieving, from a database, an event list including a plurality of wagering events and displaying the list of wagering events on the mobile computing device. The method also includes receiving a request to generate a parlay wager, selecting a first wagering event and a second wagering event, and generating a parlay wager based on the selected first and second wagering events. The method also includes determining the outcome of each of the first and second wagering events, and providing an award to the user determined as a function of the first and second wagering event outcomes and the generated parlay wager.

### CROSS-REFERENCE TO RELATED APPLICATIONS

This application claims the benefit of U.S. Provisional Application No. 61/586,151, filed Jan. 13, 2012, the disclosure of which is incorporated herein by reference.

### TECHNICAL FIELD

The subject matter disclosed herein relates generally to placing wagers on sporting events and more particularly, to system and method for allowing users to place parlay wagers via mobile computing devices.

### BACKGROUND OF THE INVENTION

Sports betting has become a popular activity at casinos and sportsbooks by allowing a person to place wagers on the outcomes of sporting events thus increasing a person's interest in the outcome and enjoyment of watching the sporting event. Accordingly, some sportsbooks include betting systems that enable a user to place wagers via a kiosk located within the sportsbook or located within the casino.

Many sportsbooks allow users to place parlay wagers including a single wager that depends on the outcome of several sporting events and may display lists of parlay wagers that are offered by the sportsbook. It is known to display parlay wagers that are predefined by the sportsbook, in that these wagers are limited to predefined sports, to teams competing within the same league, and/or to teams competing on the same day. In addition, such known betting systems display parlay bets that are limited to allowing players only to place wagers that involve selecting a winning team and involve the score differential between the winning and losing teams.

Players are attracted to the challenges offered by new wagering opportunities and may become frustrated at the limited number of parlay wagers available and the predefined sporting events eligible for a parlay wager. Likewise, sportsbooks desire new wagering opportunities to appeal to their player customers and entice players to place additional wagers. Accordingly, there is a continued need for systems and methods that create, provide and facilitate new and interesting parlay wagers.

### SUMMARY OF THE INVENTION

The invention is generally directed to systems and methods for providing new and interesting parlay wagers.

In one aspect of the invention, a method of allowing a user to place a parlay wager via a mobile computing device is provided. The method includes receiving, from the mobile computing device, a request to display information associated with a plurality of wagering events, and retrieving, from a database, an event list including a plurality of wagering events and displaying the list of wagering events on the mobile computing device. The method also includes receiving a request to generate a parlay wager, selecting a first wagering event from the plurality of wagering events based on a user selection input, selecting a second wagering event from the plurality of wagering events based on a user selection input, and generating a parlay wager based on the selected first and second wagering events. The method also includes determining the outcome of each of the first and second wagering events, and providing an award to the user determined as a function of the first and second wagering event outcomes and the generated parlay wager.

In another aspect of the invention, a system for allowing a user to place parlay wagers via a mobile computing device is provided. The system includes a plurality of mobile computing devices and a system controller that is coupled to each mobile computing device. Each mobile computing device including a user input device for accepting a user's selection input and a display device. The system controller is configured to receive, from at least one of the mobile computing devices, a request to display information associated with a plurality of wagering events, retrieve, from a database, an event list including a plurality of wagering events, and display the list of wagering events on the mobile computing device. The system controller receives a request to generate a parlay wager, selects a first wagering event and a second wagering event from the plurality of wagering events based on a user selection input and generates a parlay wager based on the selected first and second wagering events. The system controller determines the outcome of each of the first and second wagering events, and provides an award to the user determined as a function of the first and second wagering event outcomes and the generated parlay wager.

In yet another aspect of the invention, one or more non-transitory computer-readable storage media, having computer-executable instructions embodied thereon is provided. The computer-executable instructions, when executed by at least one processor, cause the processor to receive a request from a user to display information associated with a plurality of wagering events, and retrieve, from a database, an event list including a plurality of wagering events and displaying the list of wagering events on a mobile computing device. The computer-executable instructions also cause the processor to receive a request to generate a parlay wager, select a first wagering event and a second wagering event from the plurality of wagering events based on a user selection input, and generate a parlay wager based on the selected first and second wagering events. The computer-executable instructions also cause the processor to determine the outcome of each of the first and second wagering events, and provide an award to the user determined as a function of the first and second wagering event outcomes and the generated parlay wager.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a schematic representation of an exemplary system, according to an embodiment of the invention;

FIG. 2 is a flowchart of a method that may be used with the system shown in FIG. 1 for allowing a user to place a parlay wager via a mobile computing device, according to an embodiment of the invention;

FIGS. 3-8 are graphical interfaces that may be used with the method shown in FIG. 2, according to an embodiment of the invention.

Corresponding reference characters indicate corresponding parts throughout the drawings.

### DETAILED DESCRIPTION OF THE PREFERRED EMBODIMENT

With reference to the drawings and in operation, the invention overcomes at least some of the disadvantages of known betting systems by providing, among other things, systems and methods which enable a user to place a parlay wager using a one-layer betting interface displayed on a mobile computing device. For example, systems and methods of the invention are configured to display a list that includes a plurality of wagering events, receive user selections of one or more wagering events to include in a parlay wager, store information regarding the user selections and winning criteria for the parlay wager, receive data regarding the events included in the parlay wager, compare the data received with the winning criteria for the parlay wager and award a payout if the winning criteria for the parlay wager is satisfied.

Systems and methods of the invention are also configured to determine whether a selected wagering event is eligible to be included in a parlay wager and generate the parlay wager based on the selected wagering events. The system also prompts the user to input a bet amount for the parlay wager and request verification from the user before recording the parlay wager and deducting a corresponding amount from the user's financial account. By displaying a list of wagering events and allowing the user to select wagering events to include in a parlay wager, the user interest and excitement in the sporting events associated with the parlay wager is increased. Thus, the amount of parlay wagers made by the user is increased.

In some embodiments, the term “parlay wager” refers generally to a single wager that is determined as a function of two or more wagers associated with corresponding wagering events. As used herein, the term “wagering event” is any event that includes an outcome and a wager type associated with the event outcome. For example, in some embodiments, a wagering event may include, but is not limited to, a winner of a sporting contest, a placement in a race, a score of a contest, and/or any other event that includes an outcome for which a wager may be made and the result of which determines whether the wager is won or lost. In some embodiments, the term “wager type” refers generally to the type of wager made related to an outcome of a contest. For example, in some embodiments, a wager type may include an outright bet including a bet on the winner of an event, race or tournament, a moneyline bet including bet on one competitor or team to defeat another in an event or to be placed higher in an event match-up, an Over/Under bet including a bet that is determined by the total number of points (goals, games etc) in the final result of an Event, a Handicap bet when one competitor or team receives a virtual head start (effectively leading by that head start before the Event begins), an Odd/Even bet that is determined by whether the total number of points (goals, games etc) in the final result of an event is Odd or Even, a Half-time/Full-time bet to predict both the Half-time result and Full-time result of an event, and/or any suitable wager that may be made based on the outcome of an event. In some embodiments, a parlay wager is won if each of the wagers included in the parlay wager is a winning wager. Moreover, an award is provided for a winning parlay wager if each of the corresponding wagers result in a winning outcome. Several variations of parlay wagering and wagering types are known in the art, each of which is included within the scope of the embodiments described herein.

In general, the system 10 receives a request from a user via a mobile computing device to generate a parlay wager including a plurality of wagering events. In response to the received request, the system retrieves an event list including a plurality of wagering events and displays the list of wagering events on the mobile computing device. The user selects two or more wagering events from the event list and transmits a request to generate a parlay wager. The system determines whether the selected wagering events are included in a collection of wagering events eligible for a parlay wager, and generates the parlay wager based on the selected wagering events. The system 10 may also prompt the user to input a bet amount, e.g. a stake amount, associated with the generated parlay wager, and displays, on the mobile computing device, a verification request including the parlay wager including the selected wagering events and the bet amount. Upon receiving a verification message from the user, the system 10 records the parlay wager. The system 10 also monitors and determines the outcomes of the selected wagering events and provides an award to the user determined as a function of the selected wagering event outcomes, the generated parlay wager, and the bet amount associated with the parlay wager.

A selected embodiment of the invention will now be explained with reference to the drawings. It will be apparent to those skilled in the art from this disclosure that the following description of the embodiment of the invention is provided for illustration only and not for the purpose of limiting the invention as defined by the appended claims and their equivalents.

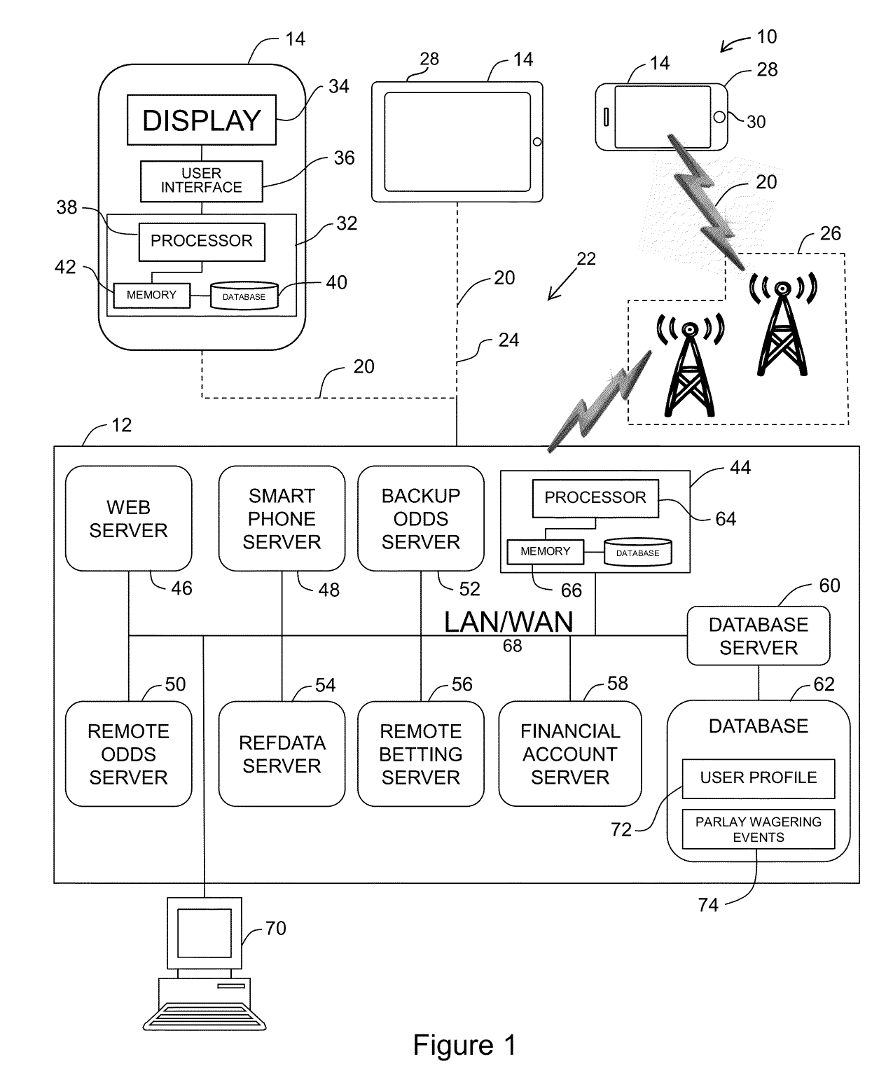

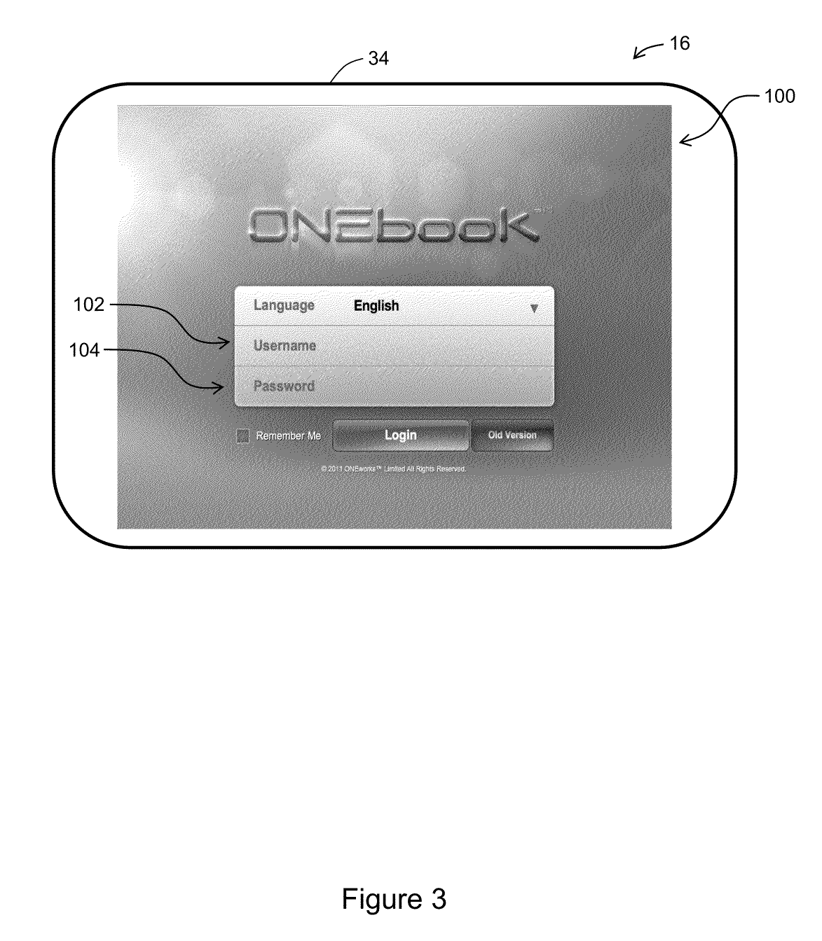

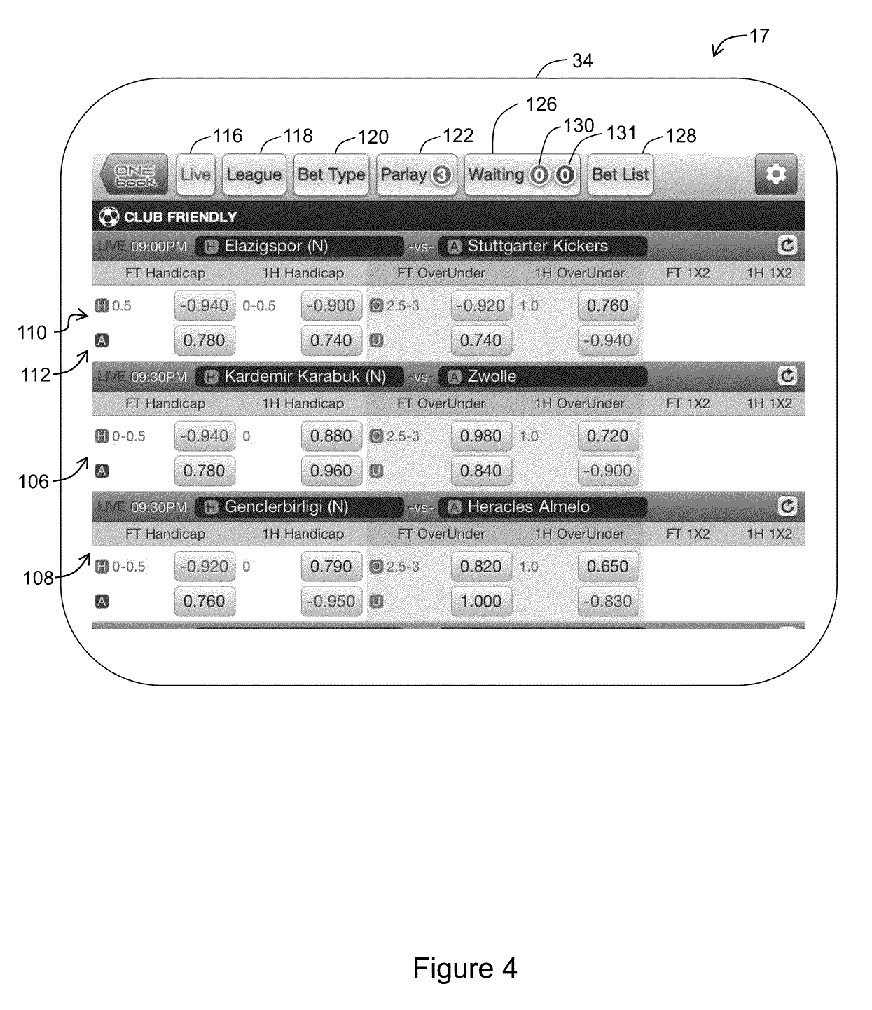

FIG. 1 is a schematic representation of the system 10, according to an embodiment of the invention. In the illustrated embodiment, the system 10 includes a server system 12 that is coupled to one or more client computing devices 14. Each client computing device 14 is configured to transmit and receive data to and/or from the server system 12 to display graphical interfaces 16, 17, 18, 19, 21, and 23 (shown in FIGS. 3-8) to enable a user to generate a parlay wager via the client computing device 14. In the illustrated embodiment, the server system 12 is coupled to each client computing device 14 via a communications link 20 that enables each client computing device 14 to access server system 12 over a network 22, such as the Internet 24, a cellular network 26, a wireless network and/or any suitable mobile telecommunication network that enables the client computing devices 14 to access the server system 12. For example, in one embodiment, the client computing device 14 includes a mobile computing device 28, e.g. a smartphone 30 that communicates with the server system 12 via the cellular telecommunications network 26 and/or the Internet 24. In another embodiment, the client computing device 14 may include a personal computer, laptop, cell phone, tablet computer, smartphone/tablet computer hybrid, personal data assistant, and/or any suitable computing device that enables a user to connect to the server system 12 and display the graphical interfaces 16, 17, 18, 19, 21, and 23 (shown in FIGS. 3-8).

In the illustrated embodiment, each client computing device 14 includes a controller 32 that is coupled to a display device 34 and a user input device 36. The display device 34 includes, without limitation, a flat panel display, such as a cathode ray tube display (CRT), a liquid crystal display (LCD), a light-emitting diode display (LED), active-matrix organic light-emitting diode (AMOLED), a plasma display, and/or any suitable visual output device capable of displaying graphical data and/or text to a user. Moreover, the user input device 36 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables a user to input data into the controller 32 and/or to retrieve data from the controller 32. Alternatively, a single component, such as a touch screen, a capacitive touch screen, and/or a touchless screen, may function as both the display device 34 and as the user input device 36.

In the illustrated embodiment, the controller 32 includes a processor 38, a database 40, and a memory device 42 that is coupled to the processor 38 and the database 40. The memory device 42 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the processor 38 to store, retrieve, and/or execute instructions and/or data. The processor 38 executes various programs, and thereby controls other components of the controller 32 and the client computing device 14 according to user instructions and data accepted by the user input device 36. The processor 38 in particular displays a graphical interfaces 16, 17, 18, 19, 21, and 23 (shown in FIGS. 3-8), and thereby enables the system 10 to generate wagers in response to user instructions received via the client computing devices 14 in accordance with the embodiments described herein. The memory device 42 stores programs and databases used by the processor 38. Moreover, the memory device 42 stores and retrieves information in the database 40 including, but not limited to, image data for producing images and/or screens on the display device 34, and temporarily stores variables, parameters, and the like that are used by the processor 38.

In the illustrated embodiment, the server system 12 include a system controller 44, a web server 46, a smartphone server 48, a remote odds server 50, a backup odds server 52, a reference data server 54, a remote betting server 56, a financial account server 58, a database server 60, and a database 62. Moreover, the system controller 44 includes a processor 64 and a memory device 66, and communicates with each client computing device 14 to enable the user to access the server system 12. The system controller 44 is connected to the servers 46, 48, 50, 52, 54, 56, 58, and 60, and the database 62 through a network 68 such as, for example, a local area network (LAN), a wide area network (WAN), dial-in-connections, cable modems, wireless modems, and/or special high-speed Integrated Services Digital Network (ISDN) lines. Moreover, at least one administrator workstation 70 is also coupled to the network 68 to enable communication with the server system 12. Alternatively, the workstation 70 may be coupled to the network 68 using an Internet link or may be coupled through an intranet.

The web server 46 and the smartphone server 48 communicate with the client computing devices 14 to facilitate transmitting data over the network 22 via the Internet 24 and/or the cellular network 26, respectively. The reference data server 54 includes data associated with images that are displayed on the client computing devices 14.

The database server 60 is connected to the database 62 containing information on a variety of matters, such as, for example, account information related to a user, user profile information, and/or wagering event information. In one embodiment, the database 62 includes a centralized database that is stored on server system 12 and is accessed directly via the client computing devices 14. In an alternative embodiment, the database 62 is stored remotely from the server system 12 and may be non-centralized. In the illustrated embodiment, the database 62 includes a user profile program 72 that includes a plurality of user profile accounts and a plurality of corresponding unique user identifiers. For example, in one embodiment, the unique user identifier may include a combination of a username and password. Alternatively, in another embodiment, the unique user identifier may include a personal identification number, or a random identification number assigned to a corresponding user account. In the illustrated embodiment, the system 10 uses the unique user identifier to identify the user and provide access to the server system 12 via a client computer device associated with the unique user identifier. For example, in one embodiment, the unique user identifier may include a mobile device identifier, such as, for example, a cellular phone number and/or wireless internet address for identifying a client computing device 14 associated with a user account.

Each user profile account includes personal identification information such as, for example, a user name, address, personal identification number, email address, mobile phone number, and/or any suitable information that enables the system 10 to function as described herein. In one embodiment, the user profile account may include a collection of user-defined categories that are indicative of preferred wagering events. For example, in one embodiment, the user profile account may include a list of preferred sporting events, betting odds, leagues, teams, racers, sports, wager types, and/or any suitable event category identified by the associated user. In addition, in the illustrated embodiment, the database 62 includes a parlay wagering events program 74 that includes a collection of wagering events including a plurality of wagering events that may be included in a parlay wager.

In the illustrated embodiment, the betting server 56 includes an event list that includes a plurality of wagering events that are available for display on the client computing devices 14. The remote odds server 50 and the backup odds server 52 each include betting odds associated with wager types associated with each wagering event. During operation, upon receiving a request from a client computing device 14, the system controller 44 retrieves the information associated with each wagering event from the event list and retrieves information associated with betting odds and wager types associated with each wagering event for display on the client computing device 14. For example, in one embodiment, the system controller 44 receives a request from a client computing device 14 to display available wagering events. The system controller 44 transmits a request to the betting server 56 to receive a list of available wagering events for display on the client computing device 14. In addition, the system controller 44 transmits a request for betting odds associated with each wagering event included in the list of available wagering events to the remote odds server 50, and receives, from the remote odds server 50 the betting odds and bet types associated with each available wagering event for display on the client computing device 14.

The financial account server 58 includes financial account information associated with each user profile account. More specifically, the financial server 58 includes a financial account and a wager account associated with each user profile account. Each financial account includes data that is indicative of financial information associated with a user profile. The financial information may include, but is limited to, available monetary funds for use in placing a wager, an available account balance, an amount of betting credits, a plurality of currency values, and/or any suitable financial information that enables the system 10 to function as described herein. The wager account includes information associated with each wager requested by the user including, but not limited to, a list of wagers made by the user, an wager amount associated with each wager, a list of active wagers, a list a past wagers made by the user, and/or any suitable information indicative of a wager.

During operation, the system controller 44 receives a selection indicative of a wagering event and/or parlay wager from a client computing device 14 including an amount of a wager associated with the wagering event and/or parlay wager. The system controller 44 sends a verification message to the financial server 58 including a unique user identifier and an amount associated with the requested wager. The financial server 58 determines the financial account associated with the unique user identifier and determines if sufficient monetary funds are available in the user financial account determined as a function of the wager amount. If the financial server 58 determines sufficient funds are available in the user financial account, the financial server 58 sends a verification message to the system controller 44 and deducts an amount from the user financial account equal to the amount of the wager. The financial server 58 creates a record of the requested wager including the wager amount deducted from the user financial account in the wager account. The system controller 44 determines the outcome of the wager and/or parlay wager and provides an award to the user based on the wager outcome, and provides a credit to the user financial account that is equal to the wager award.

In the illustrated embodiment, the workstation 70 includes a display and user input device to enable an administrative user to access the server system 12 to transmit data indicative of the wagering events and/or betting odds to the database server 60, the remote betting server 56 and/or the remote odds server 50 respectively. This enables an administrative user to periodically update betting odds associated with wagering events, wagering events included in the collection of parlay wagering events, available wagering events, wagering event outcomes, and/or any suitable data and information that enables the system 10 to function as described herein.

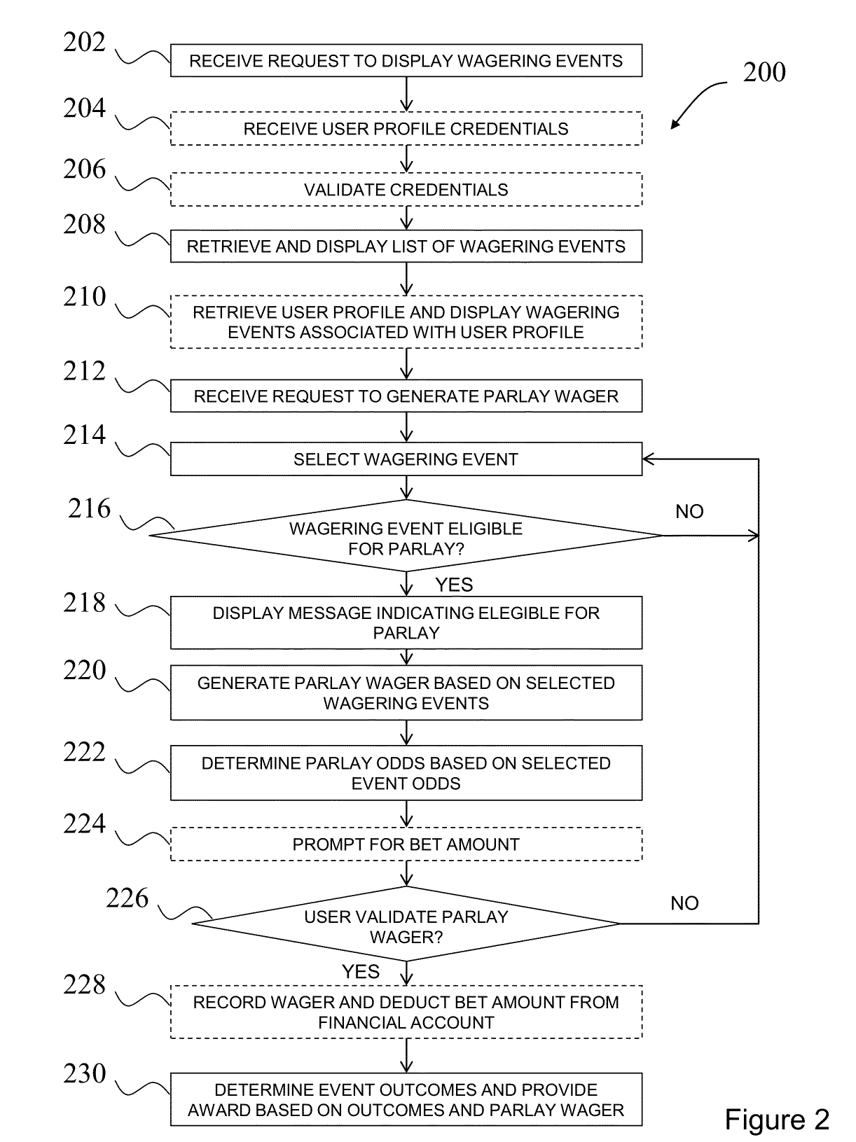

FIG. 2 is a flowchart of a method 200 that may be used with the system 10 for allowing a user to place a parlay wager via a client computing device 14. Portions of the method 200 may be performed by any one of, or any combination of, the server system 12 and/or the client computing devices 14. FIGS. 3-8 are graphical interfaces 16, 17, 18, 19, 21, and 23 respectively that may be used with method 200. In the illustrated embodiment, graphical interfaces 16, 17, 18, 19, 21, and 23 are presented by the client computing device 14 via the display device 34 (shown in FIG. 2) and may receive input (e.g., selections and/or entries) via the user input device 36 (shown in FIG. 2). For example, in one embodiment, a selection may be received via user input device 36 of the mobile computing device 28 and may be transmitted by the mobile computing device 28 to the server system 12 via the network 22.

In the illustrated embodiment, the method 200 includes receiving 202 a request to display information including a plurality of wagering events from a client computing device 14. In one embodiment, the user may submit the request by accessing a website via webserver 46. In another embodiment, the user may access a mobile website via the cellular network 26. In addition, in one embodiment, the method 200 may include receiving 204 a unique user identifier to validate the request to display wagering events. More specifically, the system controller 44 may display a login screen 100 on graphical interface 16 (shown in FIG. 3) on the client computing device 14 to request the unique user identifier such as, for example requesting a username 102 and/or password 104. The system controller 44 receives the unique user identifier and transmits a validation request including the user credentials to the database server 60. The database server 60 compares the received unique user identifier with the collection of unique user identifier contained in the user profile program 72 to validate 206 the unique user identifier and responsively sends a validation message to the system controller 44 if the received unique user identifier is included in the user profile program 72. Upon receiving the validation message from the database server 60 the system controller 44 displays a listing a wagering events.

In the illustrated embodiment, the method 200 includes retrieving 208 an event list 106 including a plurality of wagering events and displaying the list of wagering events on the client computing device 14. For example, in one embodiment, the system controller 44 may retrieve a plurality of wagering events from the event list 106 and display each the wagering event in an event area 108 on the graphical interface 17. In addition, the system controller 44 displays each wagering event 110 in a corresponding user selection area 112 such that each displayed wagering event 110 is selectable by the user via the user input device 36. In the illustrated embodiment, the system controller 44 retrieves a list of wagering events from the betting server 56 and retrieves the betting odds corresponding with each listed wagering event from the odds server 50 and displays each wagering event and associated betting odds including each corresponding bet type associated with the wagering event.

In one embodiment, the system controller 44 transmits a user profile request to the database server 60 including the unique user identifier and retrieves 210 the corresponding user profile account including a collection of user-defined categories indicative of preferred wagering events from the database server 60. The system controller 44 determines the user profile account associated with the unique identifier, selects a plurality of wagering events from the event list based on the user-defined categories, and displays the selected wagering events in the event area 108.

In the illustrated embodiment, the system controller 44 displays a plurality of user selection areas 112 within the graphical interface 17 that correspond to specific operations that may be initiated by the user. For example, in the illustrated embodiment, the system controller 44 displays a “live wagering event” selection area 116, a “league” selection area 118, a “bet type” selection area 120, a “parlay wager” selection area 122, an “add to parlay wager” selection area 124 (shown in FIG. 6), a “bet waiting” selection area 126, and a “bet list” selection area 128. Each of the areas 116, 118, 120, 122, 124, 126, and 128 may receive a user selection input via the user input device 36. In one embodiment, upon receiving a user selection input associated with the “live wagering event” selection area 116, the system controller 44 displays, in the event area 108, a listing of wagering events currently in progress at the time the selection is made. Moreover, the system controller 44 displays a plurality of sport leagues that each includes one or more wagering events in the event area 108 upon receiving a user request via the “league” selection area 118.

The system controller 44 also displays the list of wagering events organized by bet type in response to receiving a user selection input associated with the “bet type” selection area 120. The system controller 44 may also display a number of wagers that have been selected by the user, but not validated, upon receiving a user request via the “bet waiting” selection area 126. In one embodiment, the system controller 44 may display a number 130 of wagers currently selected by the user in the “bet waiting” selection area 126, and may display a number 131 of wagers recorded by the user but rejected or void. In addition, the system controller 44 may display graphical interface 23 (shown in FIG. 8) in the event area 108 a listing of bets that have been made and validated by the user in response to a user selection within the “bet list” selection area 128. In one embodiment, the system controller 44 may display a selected wagers area 132 in the graphical interface 18 that includes a list of wagering events that have been selected by the user.

In the illustrated embodiment, the method 200 includes receiving 212 a request to generate a parlay wager. More specifically, the system controller 44 receives a selection corresponding to a first wagering event 134 and selects 214 the first wagering event 134 from the event list in response to a user selection input received in the event area 108 that corresponds to the selected wagering event (as shown in FIG. 6). The system controller 44 transmits a verification message to the database server 60 to determine 216 if the selected first wagering event 134 is included in the parlay wagering events program 74, and responsively displays the selected first wagering event 134 in a wager selection area 136 if the selected wagering event 134 is verified.

In the illustrated embodiment, upon determining the selected wagering event 134 is eligible for a parlay wager, the system controller 44 displays 218 the “add to parlay wager” selection area 124 on the graphical interface 19 to indicate to the user that the selected wagering event 134 is eligible to be included in a parlay wager and to enable the user to add the selected wagering event 134 to the parlay wager. If the selected first wagering event 134 is not included in the parlay wagering events program 74, the system controller 44 does not include the selected first wagering event 134 in the parlay wager and does not display the “add to parlay wager” selection area 124. The user then selects another wagering event to be included in the parlay wager. Moreover, the user then selects a second wagering event 138 from the event area 108 and selects the “add to parlay wager” selection area 124. The system controller 44 validates the selected second wagering event 138 with the database server 60, determines a number of wagering events selected by the user, and displays a notification message 140 including the determined number of wagering events in the “parlay wager” selection area 122 to indicate the number of selected wagering events being included in the parlay wager.

In one embodiment, the system controller 44 may require a predetermined number of wagering events to be included in the parlay wager. After each wager event selection, the system controller 44 determines a number of wagering events selected by the user, and responsively generates the parlay wager if the determined number of user-selected wagering events is equal to a predefined number of wagering events. In addition, if the number of selected wagering events is not equal to the predefined number of wagering events, the system controller 44 displays a notification message to the user to indicate to the user that additional wagering event selections are required for the parlay wager.

In the illustrated embodiment, the user sends a request to generate a parlay wager based on the selected wagering events by selecting the “parlay wager” selection area 122, and, in response to the user's request, the system controller 44 generates 220 the parlay wager including the selected wagering events. Moreover, the system controller 44 retrieves the odds associated with the generated parlay wager selected from the odds server 50, and determines 222 the odds associated with the parlay wager. In one embodiment, the system controller 44 may determine a first betting odds associated with the first wagering event, determine a second betting odds associated with the second wagering event, and generate a parlay wager odds determined as a function of the first wagering event odds and the second wagering event odds. In one embodiment, the first wagering event 134 may be associated with a first sport and the second wagering may be associated with a second sport that is different from the first sport. Moreover, the first and second wagering events may include different leagues, different bet types, different odds, and/or any combination of teams, leagues, players, horses, vehicles, bet types, and/or odds.

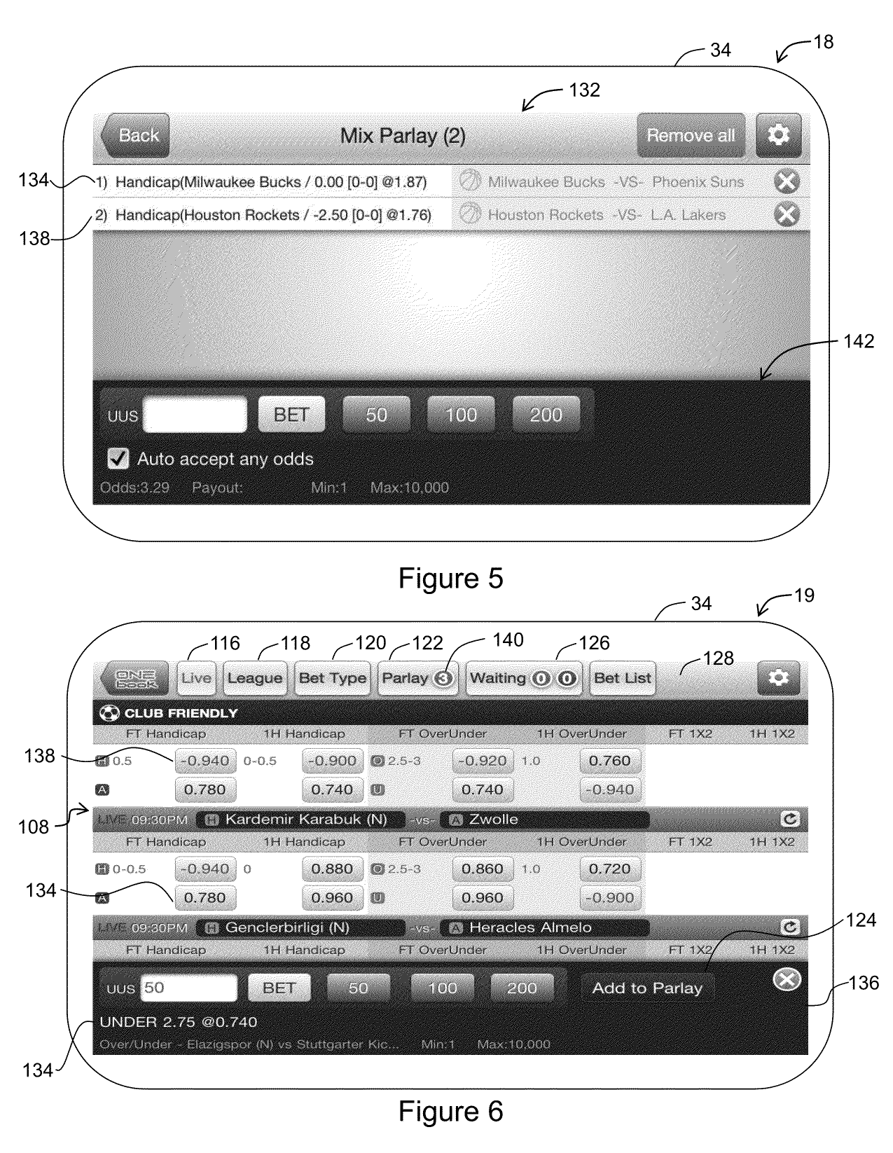

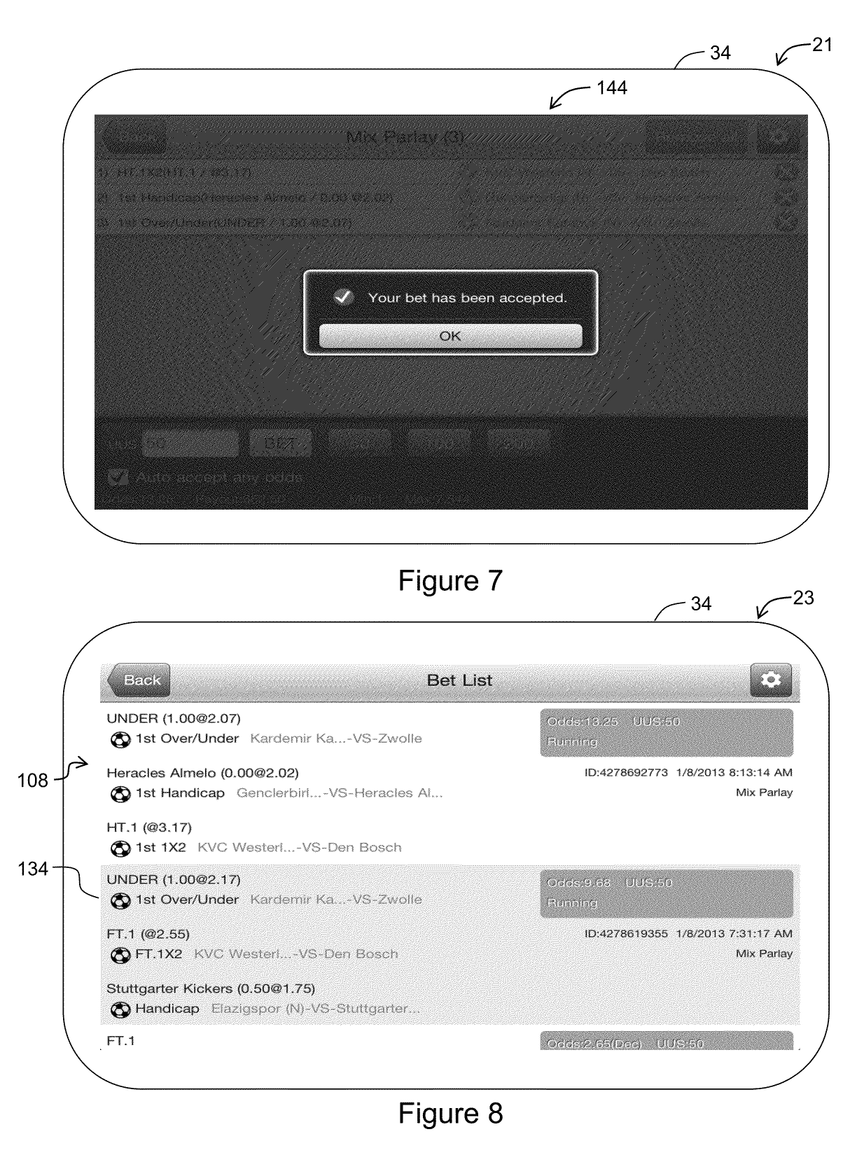

In one embodiment, the system controller 44 may display 224 a notification message 142 on graphical interface 18 (shown in FIG. 5) including a request for a bet amount associated with the parlay wager request. Upon receiving a bet amount in response to the displayed notification message, the system controller 44 may generate the parlay wager as a function of the received bet amount, and may display a verification message 144 on graphical interface 21 (shown in FIG. 7) to indicate to the user that the parlay wager has been accepted. In one embodiment, the system controller 44 transmits a verification message to the financial server 58 to verify the user financial account includes sufficient funds to fund the bet. If the user financial account does not have sufficient funds, the system controller 44 may display a message to the user to indicate that insufficient funds are available to fund the bet and prompt the user to deposit additional funds in the corresponding user financial account.

In the illustrated embodiment, the system controller 44 displays 226 a verification message (shown in FIG. 5) including a request to verify the generated parlay wager, and generates the parlay wager in response to a verification signal received from the user. The system controller 44 responsively displays a summary message indicative of the verified parlay wager. In one embodiment, the summary message includes the selected first and second wagering events and the bet amount. If the parlay wager is not verified by the user after a predefined period of time, the system controller 44 does not generate the parlay wager.

In one embodiment, upon receiving a validation response from the user, the system controller 44 records 228 the parlay wager in the financial server 58 including the wager amount associated with the parlay wager, and deducts the wager amount from the user financial account.

In the illustrated embodiment, the system controller 44 monitors each wagering event and displays the outcome of each wagering event upon receiving a user selection input associated with the “live wagering event” selection area 116. The system controller 44 determines 230 the outcome of each of the selected wagering events included in the parlay wager, and provides an award to the user determined as a function of the wagering event outcomes and the generated parlay wager.

An exemplary technical effect of the methods, systems, and computers described herein includes at least one of (a) receiving, from the mobile computing device, a request to display information associated with a plurality of wagering events; (b) retrieving, from a database, an event list including a plurality of wagering events and displaying the list of wagering events on the mobile computing device; (c) receiving a request to generate a parlay wager; (d) selecting a first wagering event from the plurality of wagering events based on a user selection input; (e) selecting a second wagering event from the plurality of wagering events based on a user selection input; (f) generating a parlay wager based on the selected first and second wagering events; (g) determining the outcome of each of the first and second wagering events; and (h) providing an award to the user determined as a function of the first and second wagering event outcomes and the generated parlay wager.

The above-described systems and methods overcome at least some disadvantages of known betting systems by enabling a user to place a parlay wager using a one-layer betting interface displayed via a mobile computing device. The embodiment described herein display a list that includes a plurality of wagering events, enable the user to select one or more wagering events to include in a parlay wager, determine whether the selected wagering event is eligible to be included in a parlay wager, and generate the parlay wager based on the selected wagering events. By allowing the user to select wagering events to include in a parlay wager, the user's interest and excitement in the sporting events associated with the parlay wager is increased. Thus, the amount of parlay wagers may by the user is increased.

Exemplary embodiments of a system and method of allowing a user to place a parlay wager via a mobile computing device are described above in detail. The system and method are not limited to the specific embodiments described herein, but rather, components of the system and/or steps of the method may be utilized independently and separately from other components and/or steps described herein. For example, the system may also be used in combination with other wagering systems and methods, and is not limited to practice with only the system as described herein. Rather, an exemplary embodiment can be implemented and utilized in connection with many other wagering applications.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A method of allowing a user to place a parlay wager via a mobile computing device, comprising the steps of:
receiving, from the mobile computing device, a request to display information associated with a plurality of wagering events;
retrieving, from a database, an event list including a plurality of wagering events and displaying the list of wagering events on the mobile computing device;
receiving a request to generate a parlay wager;
selecting a first wagering event from the plurality of wagering events based on a user selection input;
selecting a second wagering event from the plurality of wagering events based on a user selection input;
generating a parlay wager based on the selected first and second wagering events;
determining the outcome of each of the first and second wagering events; and
providing an award to the user determined as a function of the first and second wagering event outcomes and the generated parlay wager.

2. A method in accordance with claim 1, further comprising the steps of:
displaying a notification message including a request for a bet amount associated with the parlay wager request;
receiving, from the user, a bet amount in response to the displayed notification message; and
generating the parlay wager as a function of the received bet amount.

3. A method in accordance with claim 2, further comprising the steps of:
displaying a verification message including a request to verify the generated parlay wager; and
generating the parlay wager in response to a verification signal received from the user.

4. A method in accordance with claim 3, further comprising the step of displaying a summary message indicative of the verified parlay wager, the summary message including the selected first and second wagering events and the bet amount.

5. A method in accordance with claim 1, further comprising the steps of:
determining a first betting odds associated with the first wagering event;
determining a second betting odds associated with the second wagering event; and
providing the award determined as a function of the first betting odds and the second betting odds.

6. A method in accordance with claim 1, further comprising the steps of:
determining if the first wagering event and the second wagering event are each included in a collection of eligible parlay wagering events; and
responsively generating the parlay wager after determining each of the first and second wagering events is included in the collection of eligible parlay wagering events.

7. A method in accordance with claim 1, further comprising the steps of determining if the first wagering event is included in a collection of eligible parlay wagering events and responsively displaying a notification to the user indicating the selected first wagering event is eligible for the parlay wager.

8. A method in accordance with claim 1, further comprising the steps of:
determining a number of wagering events being selected by the user; and
displaying a notification message including the determined number of wagering events to indicate the number of selected wagering events being included in the parlay wager.

9. A method in accordance with claim 1, further comprising the steps of:
determining a number of wagering events being selected by the user; and
responsively generating the parlay wager if the determined number of user-selected wagering events is equal to a predefined number of wagering events.

10. A method in accordance with claim 1, wherein the first wagering event being associated with a first sport, the second wagering event being associated with a second sport that is different from the first sport.

11. A method in accordance with claim 1, further comprising the steps of:
receiving a unique identifier associated with the user;
determining a user profile associated with the unique identifier, the user profile including a collection of user-defined categories indicative of preferred wagering events;
selecting a plurality of wagering events from the event list based on the user-defined categories; and
displaying the selected wagering events in response to the user request.

12. A system for allowing a user to place parlay wagers via a mobile computing device, comprising:
a plurality of mobile computing devices, each mobile computing device including a user input device for accepting a user's selection input and a display device; and
a system controller coupled to each mobile computing device of the plurality of mobile computing devices, the system controller for receiving, from at least one of the mobile computing devices, a request to display information associated with a plurality of wagering events, for retrieving, from a database, an event list including a plurality of wagering events and displaying the list of wagering events on the mobile computing device, for receiving a request to generate a parlay wager, for selecting a first wagering event from the plurality of wagering events based on a user selection input, for selecting a second wagering event from the plurality of wagering events based on a user selection input, for generating a parlay wager based on the selected first and second wagering events, for determining the outcome of each of the first and second wagering events, and for providing an award to the user determined as a function of the first and second wagering event outcomes and the generated parlay wager.

13. A system in accordance with claim 12, the system controller for displaying a notification message including a request for a bet amount associated with the parlay wager request, for receiving, from the user, a bet amount in response to the displayed notification message, and for generating the parlay wager as a function of the received bet amount.

14. A system in accordance with claim 13, the system controller for displaying a verification message including a request to verify the generated parlay wager, and for generating the parlay wager in response to a verification signal received from the user.

15. A system in accordance with claim 14, the system controller for displaying a summary message indicative of the verified parlay wager, the summary message including the selected first and second wagering events and the bet amount.

16. A system in accordance with claim 12, the system controller for determining a first betting odds associated with the first wagering event, for determining a second betting odds associated with the second wagering event, and for providing the award determined as a function of the first betting odds and the second betting odds.

17. A system in accordance with claim 12, the system controller for determining if the first wagering event and the second wagering event are each included in a collection of eligible parlay wagering events, and for responsively generating the parlay wager after determining each of the first and second wagering events is included in the collection of eligible parlay wagering events.

18. A system in accordance with claim 12, the system controller for determining if the first wagering event is included in a collection of eligible parlay wagering events and responsively displaying a notification to the user indicating the selected first wagering event is eligible for the parlay wager.

19. A system in accordance with claim 12, the system controller for determining a number of wagering events being selected by the user, and for displaying a notification message including the determined number of wagering events to indicate the number of selected wagering events being included in the parlay wager.

20. A system in accordance with claim 12, the system controller for determining a number of wagering events being selected by the user, and for responsively generating the parlay wager if the determined number of user-selected wagering events is equal to a predefined number of wagering events.

21. A system in accordance with claim 12, wherein the first wagering event being associated with a first sport, the second wagering event being associated with a second sport that is different from the first sport.

22. A system in accordance with claim 12, the system controller for receiving a unique identifier associated with the user, for determining a user profile associated with the unique identifier, the user profile including a collection of user-defined categories indicative of preferred wagering events, for selecting a plurality of wagering events from the event list based on the user-defined categories, and for displaying the selected wagering events in response to the user request.

23. One or more non-transitory computer-readable storage media, having computer-executable instructions embodied thereon, wherein when executed by at least one processor, the computer-executable instructions cause the processor to:
receive a request from a user to display information associated with a plurality of wagering events;
retrieve, from a database, an event list including a plurality of wagering events and displaying the list of wagering events on a mobile computing device;
receive a request to generate a parlay wager;
select a first wagering event from the plurality of wagering events based on a user selection input;
select a second wagering event from the plurality of wagering events based on a user selection input;
generate a parlay wager based on the selected first and second wagering events;
determine the outcome of each of the first and second wagering events; and
provide an award to the user determined as a function of the first and second wagering event outcomes and the generated parlay wager.

24. The one or more computer-readable storage media according to claim 23, wherein when executed by at least one processor, the computer-executable instructions cause the processor to:
display a notification message including a request for a bet amount associated with the parlay wager request;
receive, from the user, a bet amount in response to the displayed notification message; and
generate the parlay wager as a function of the received bet amount.

25. The one or more computer-readable storage media according to claim 24, wherein when executed by at least one processor, the computer-executable instructions cause the processor to:
display a verification message including a request to verify the generated parlay wager; and
generate the parlay wager in response to a verification signal received from the user.

26. The one or more computer-readable storage media according to claim 25, wherein when executed by at least one processor, the computer-executable instructions cause the processor to display a summary message indicative of the verified parlay wager, the summary message including the selected first and second wagering events and the bet amount.

27. The one or more computer-readable storage media according to claim 23, wherein when executed by at least one processor, the computer-executable instructions cause the processor to:
determine a first betting odds associated with the first wagering event;
determine a second betting odds associated with the second wagering event; and
provide the award determined as a function of the first betting odds and the second betting odds.

28. The one or more computer-readable storage media according to claim 23, wherein when executed by at least one processor, the computer-executable instructions cause the processor to:
determine if the first wagering event and the second wagering event are each included in a collection of eligible parlay wagering events; and
responsively generate the parlay wager after determining each of the first and second wagering events is included in the collection of eligible parlay wagering events.

29. The one or more computer-readable storage media according to claim 23, wherein when executed by at least one processor, the computer-executable instructions cause the processor to determine if the first wagering event is included in a collection of eligible parlay wagering events and responsively displaying a notification to the user indicating the selected first wagering event is eligible for the parlay wager.

30. The one or more computer-readable storage media according to claim 23, wherein when executed by at least one processor, the computer-executable instructions cause the processor to:
determine a number of wagering events being selected by the user; and
display a notification message including the determined number of wagering events to indicate the number of selected wagering events being included in the parlay wager.

31. The one or more computer-readable storage media according to claim 23, wherein when executed by at least one processor, the computer-executable instructions cause the processor to:
determine a number of wagering events being selected by the user; and
responsively generate the parlay wager if the determined number of user-selected wagering events is equal to a predefined number of wagering events.

32. The one or more computer-readable storage media according to claim 23, wherein the first wagering event being associated with a first sport, the second wagering event being associated with a second sport that is different from the first sport.

33. The one or more computer-readable storage media according to claim 23, wherein when executed by at least one processor, the computer-executable instructions cause the processor to:
receive a unique identifier associated with the user;
determine a user profile associated with the unique identifier, the user profile including a collection of user-defined categories indicative of preferred wagering events;
select a plurality of wagering events from the event list based on the user-defined categories; and
display the selected wagering events in response to the user request.
